(19) United States
(12) Patent Application Publication
(10) Pub. No.: US 2024/0263045 A1
(43) Pub. Date: Aug. 8, 2024

(54) MARKER TRANSFER TAPE AND METHOD OF APPLYING MARKERS

(71) Applicant: Wichita State University, Wichita, KS (US)

(72) Inventors: Christopher Kowalczyk, Spencer, MA (US); John Laffen, Wichita, KS (US)

(73) Assignees: Wichita State University, Wichita, KS (US); FLEXcon Company, Inc., Spencer, MA (US)

(21) Appl. No.: 18/431,479

(22) Filed: Feb. 2, 2024

Related U.S. Application Data
(60) Provisional application No. 63/482,976, filed on Feb. 2, 2023.

(51) Int. Cl. C09J 7/38; C09J 5/00; C09J 7/24

(52) U.S. Cl. CPC C09J 7/38; C09J 5/00; C09J 7/241; C09J 2203/37; C09J 2301/16; C09J 2301/302; C09J 2301/502; C09J 2423/006

(57) ABSTRACT

A marker transfer tape includes a transfer material layer that extends along a length and width of the marker transfer tape and an adhesive layer along a bottom side of the transfer material layer. The marker transfer tape includes a marker separation cut that defines a first removable portion, a second removable portion, and a plurality of markers between the first and second removable portions such that the markers are centrally located along the width of the marker transfer tape and spaced apart along the length of the marker transfer tape. The markers are applied to the surface by: adhering the marker transfer tape to the surface; peeling off the first removable portion; and peeling off the second removable portion.

### CROSS-REFERENCE TO RELATED APPLICATION

This application claims priority to U.S. Provisional Patent Application No. 63/482,976, filed Feb. 2, 2023, and entitled Marker Transfer Tape and Method of Applying Markers, which is hereby incorporated by reference in its entirety for all purposes.

### FIELD

This disclosure generally pertains to a marker transfer tape and a method of applying markers to a surface for the purpose of aerodynamic testing.

### BACKGROUND

In various applications, there is a need to apply a plurality of spaced apart markers to a surface. For example, in wind tunnel testing, markers called trip dots are applied to a small-scale model to simulate a trip in the boundary layer. On smaller models, the transition from laminar flow to turbulent flow proportionally occurs further back than it would on a full-scale model. Therefore, to receive the most accurate test data from wind tunnel data, these trip dots must be carefully and accurately placed to ensure that the correct type of airflow is being analyzed along the surface of the model.

### SUMMARY

In one aspect, a marker transfer tape having a length and a width comprises a transfer material layer extending along the length and width of the marker transfer tape. The transfer material layer has a thickness and a bottom side and a top side spaced apart along the thickness. An adhesive layer along the bottom side of the transfer material layer comprises pressure sensitive adhesive. A marker separation cut is formed in the marker transfer tape. The marker separation cut extends along the length of the marker transfer tape and is located centrally along the width of the marker transfer tape. The marker separation cut spans at least the thickness of the transfer material layer such that the marker separation cut defines a first removable portion on a first side of the marker separation cut, a second removable portion on a second side of the marker separation cut, and a plurality of markers between the first removable portion and the second removable portion. The plurality of markers are spaced along the length of the marker transfer tape.

In another aspect, a method for applying markers to a surface comprises adhering a marker transfer tape to a surface. The marker transfer tape has a length and a preformed marker separation cut extending along the length. The preformed marker separation cut defines a plurality of markers spaced apart along the length of the marker transfer tape, a first removable portion along a first side of the plurality of markers, and a second removable portion along the second side of the plurality of markers. The first removable portion of the marker transfer tape is removed from the surface by separating the first removable portion from a remainder of the marker transfer tape along the preformed marker separation cut. A second removable portion of the marker transfer tape is removed from the surface by separating the second removable portion from the markers along the preformed marker separation cut, whereby the markers are applied to the surface without the first and second removable portions.

One embodiment of the present disclosure provides a marker transfer tape configured to accurately place a plurality of markers along a given surface. The marker transfer tape includes a transfer material layer that extends along a length and width of the marker transfer tape and an adhesive layer along a bottom side of the transfer material layer. The marker transfer tape further includes a marker separation cut spanning the length and a thickness of the marker transfer tape. The marker separation cut defines the first removable portion, the second removable portion, and the plurality of markers spaced along the length of the tape. The marker separation cut may be generally centrally located along the width of the marker transfer tape.

The plurality of markers may be applied to the given surface by adhering the marker transfer tape to the surface and subsequently removing the first removable portion and the second removable portion from the plurality of markers.

The marker transfer tape may have a preformed marker separation cut defining a plurality of makers spaced along the marker transfer tape and the marker transfer tape may be formed into a roll for ease of storage and application.

The markers may be trip dots used for changing the airflow over a surface as is commonly used in wind tunnel testing of aerodynamic structures such as wings.

Other objects and features will be in part apparent and in part pointed out hereinafter.

### BRIEF DESCRIPTION OF THE DRAWINGS

FIG. 1 is a plan view of a trip dot application strip of the prior art;

FIG. 2 is a plan view of a marker transfer tape in accordance with the present disclosure;

FIG. 3 is a cross section taken in the plane of line 3-3 of FIG. 2;

FIG. 4 is a cross section taken in the plane of line 4-4 of FIG. 2;

FIG. 5 is a plan view similar to FIG. 2, but showing corner regions of the marker transfer tape folded up;

FIG. 6 is a perspective of a surface with a portion of the marker transfer tape of FIG. 2 adhered thereto;

FIG. 7 is a plan view of another embodiment of marker transfer tape in accordance with the present disclosure;

FIG. 8 is a perspective of a roll of marker transfer tape in accordance with the present disclosure; and

FIG. 9 is a flow chart illustrating the steps of a method of applying trip dots in accordance with the present disclosure.

Corresponding parts are given corresponding reference characters throughout the drawings.

### DETAILED DESCRIPTION

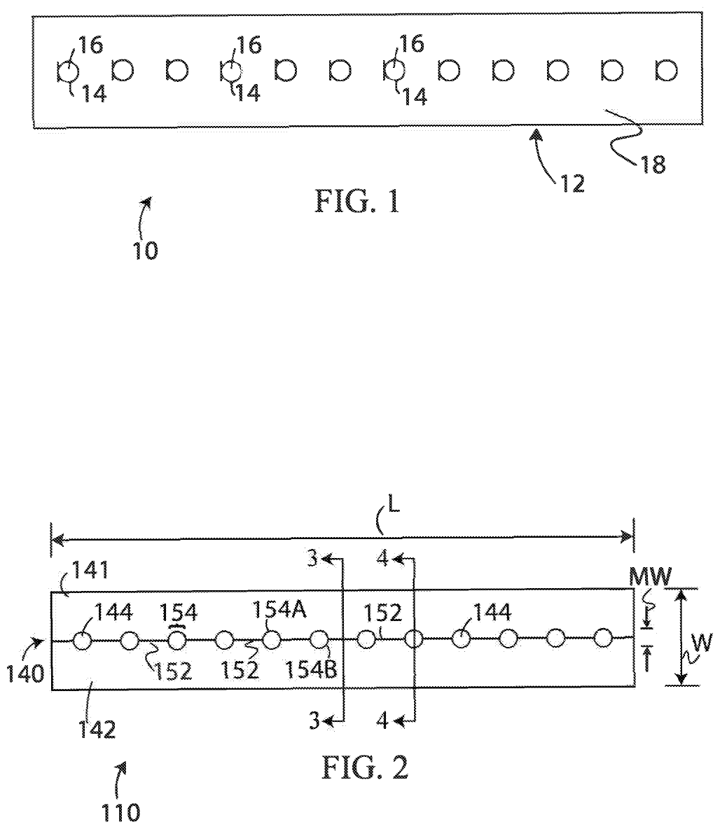

It is desirable to have a marker transfer tape and method of applying markers that allows for simple and accurate placement of said markers. Referring to FIG. 1, an example of a conventional marker application strip is generally indicated at reference number 10. The conventional marker application strip comprises transfer material 12 with pressure sensitive adhesive (hereinafter, PSA) (not shown) on a bottom side. Typical marker application strips also comprise a release layer (not shown) covering the PSA and configured to be peeled away before the marker application strip is applied. The transfer material 12 comprises a plurality of individual cuts 14 spaced apart along the length of the of the marker application strip. Each individual cut 14 defines a respective marker 16, and the remainder of the transfer material 12 forms a single contiguous removable portion 18. In the illustrated example, the cuts 14 are circular. The illustrated cuts 14 also comprise parallel cut lines tangential to the circular cuts. To apply the markers to a surface, the release layer is removed and the transfer material 12 is adhered to the surface using the PSA. Then, in theory, the removable portion 18 is peeled off of the surface and removed, leaving only the markers 16 applied to the surface, evenly spaced in a single-file line. In practice, however, it is very difficult to separate the removable portion 18. And typically, many of the markers 16 are inadvertently lifted from the surface with the removable portion 18 such that they must be reapplied individually. This leads to inaccuracy in marker placement and, more generally, is perceived as cumbersome and time-consuming. As explained more fully below, the inventors have devised a novel marker application material that can address some of the above-described deficiencies of the conventional marker application strip 10 to make the marker application process quicker, easier, and more accurate.

Referring to FIGS. 2-5, an exemplary embodiment of a marker transfer tape in the scope of the present disclosure is generally indicated at reference number 110. The marker transfer tape 110 has a length L and a width W. It will be appreciated that the length L and width W of the marker transfer tape 110 can vary from what is shown. The marker transfer tape 110 broadly comprises a transfer material layer 112 extending along the length L and width W of the marker transfer tape. The transfer material layer 112 has a thickness T and a bottom side and a top side spaced apart along the thickness. In one or more embodiments the thickness T of the transfer material layer 112 is in an inclusive range of from 0.5 mil to 25 mil (0.0127 mm to 0.635 mm), or an inclusive range of 0.75 mil to 20 mil (0.01905 mm to 0.508 mm), or an inclusive range of 1.0 mil to 15 mil (0.0254 mm to 0.381 mm), or an inclusive range of 1.5 mil to 10 mil (0.0381 mm to 0.254 mm). But it will be understood that another thickness T could be used depending on the needs of given marker application. Those skilled in the art will recognize that, at this range, the transfer material layer 112 is of a suitable thickness for forming trip dots used in wind tunnel testing. The thickness of the marker transfer tape 110 and the transfer material layer 112 may vary depending on the type of article being tested and the design requirements of the article. However, it will be understood that other embodiments of marker transfer tape in the scope of the present disclosure can be configured for applying other types of markers, and thus the thickness of the marker transfer tape will vary in accordance with the application for the markers. Any suitable material can be used for the transfer material layer 112. In an exemplary embodiment, the transfer material layer is a polymer such as a PVC-based polymer or other vinyl-based polymer. Other polymeric or metallic materials, or a combination of the polymeric and metallic materials, such as a metal coated plastic may be used for the marker transfer tape 110 and the transfer material layer 112.

In addition to the transfer material layer 112, the illustrated marker transfer tape 110 comprises an adhesive layer 122 and an optional release strip 132. The adhesive layer 122 comprises PSA disposed along the bottom side of the transfer material layer 112. The adhesive layer 122 is configured to adhere the marker transfer tape 110 to a surface (e.g., a section of a model requiring a turbulent boundary layer) when pressure is applied to the top side of the marker transfer tape 110. Any suitable PSA material can be used for the adhesive layer 122 without departing from the scope of the disclosure (e.g., natural rubber, synthetic rubber, acrylic, and silicone PSAs). The optional release strip 132 is releasably secured to the marker transfer tape 110 to cover the adhesive layer 122 prior to application of the marker transfer tape. The release strip 134 is removable to expose the adhesive layer 122 when the marker transfer tape 110 is being applied.

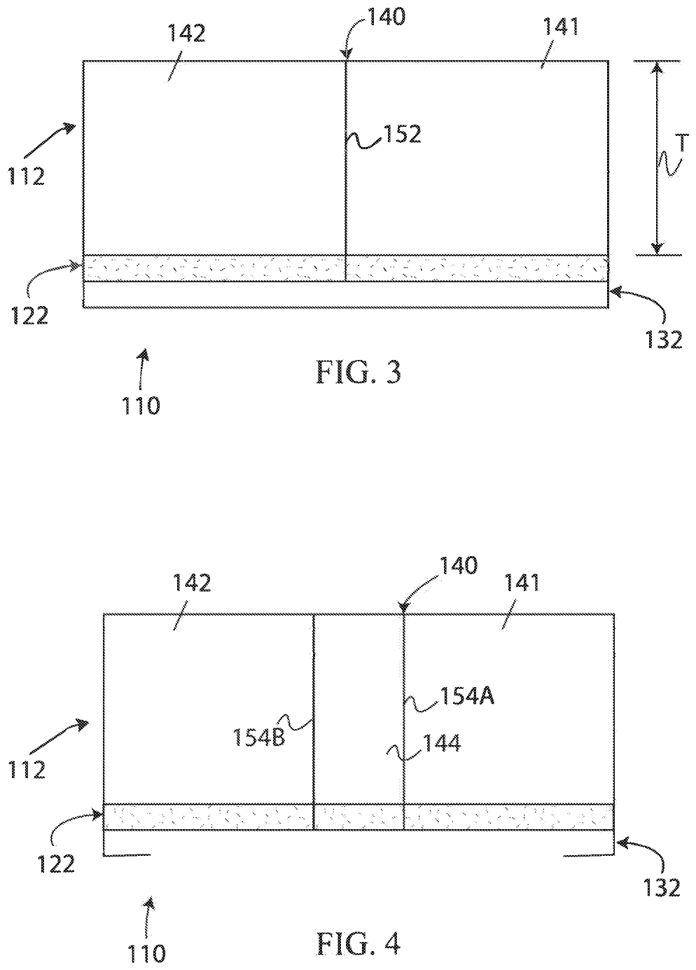

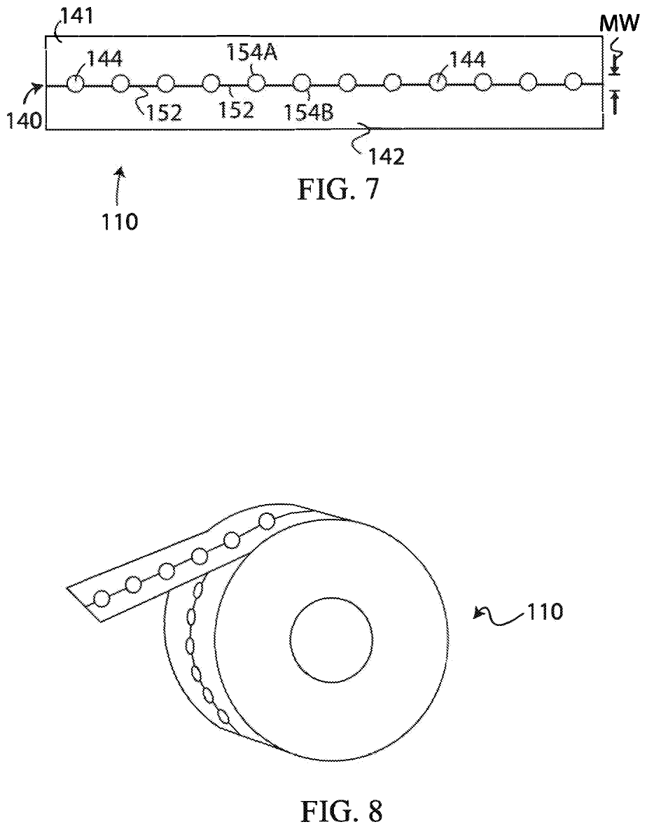

A marker separation cut 140 is formed in the marker transfer tape 110 to define a first removable portion 141 on a first side of the marker separation cut, a second removable portion 142 on an opposite second side of the marker separation cut, and a plurality of markers 144 (e.g., trip dots) between the first and second removable portions that are spaced apart along the length L of the marker transfer tape. In the illustrated embodiment, the marker separation cut 140 is a contiguous cut extending along the entire length L of the marker transfer tape 110. The marker separation cut 140 could also be non-contiguous (e.g., comprise perforations) instead of being a contiguous cut. The marker separation cut 140 is located centrally along the width W of the marker transfer tape 110 but does not need to be precisely centered widthwise along the width (see FIG. 7). Centrally located means that the marker separation cut 140 is generally located in the center of the marker transfer tape 110 and may not be centrally located to the marker 144 as shown in FIG. 7. Referring to FIGS. 3 and 4, the marker separation cut 140 spans at least the thickness T of the transfer material layer 112 but does not penetrate the release strip 132. In certain embodiments, the marker separation cut 140 can penetrate the adhesive layer 122. In one or more embodiments, the cut 140, removable portions 141, 142, and the markers 144 occupy the entire length L and width W of the marker transfer tape 110. In the illustrated embodiment, the width W of the marker transfer tape 110 extends from a first longitudinal edge to a second longitudinal edge parallel to the first longitudinal edge. The first removable portion 141 extends from the first longitudinal edge to the cut 140, and the second removable portion 142 extends from the second longitudinal edge to the cut. The first and second removable portions 141, 142 are generally parallel, with the markers 144 and cut 140 between them.

The marker separation cut 140 comprises a plurality of removable portion sections 152 and a plurality of marker sections 154 that alternate along the length L of the marker transfer tape 110. Each removable portion section 152 comprises a single cut segment. In the orientation of the marker transfer tape in FIG. 2, the single cut segment forming each removable portion section 152 has a left end (broadly, a first end) and a right end (broadly, a second end) spaced apart along the length L. The first and second removable portions 141, 142 meet at each of the removable portion sections 152.

By contrast, each marker section 154 comprises a first cut segment 154A and a second cut segment 154B that define a respective marker 144 between them. Here, the term “cut segment” is being used to describe the geometry of the marker separation cut after it is formed and does not imply that individual cut segments are formed in separate cutting process steps. On the contrary, in certain exemplary embodiments, both cut segments 154A, 154B of each marker section are formed as a single cut rather than two segmented cuts. In other embodiments, the first and second cut segments 154A, 154B could be formed as two segmented cuts.

The first removable portion 141 meets the plurality of markers 144 along the first cut segments 154A, and the second removable portion 142 meets the plurality of markers along the second cut segments 154B. In the orientation shown in FIG. 2, the first cut segment 154A and the second cut segment 154B of each marker section 154 have respective left ends (broadly, first ends) joining the right end of the adjacent single cut segment of one removable portion section 152. Likewise, the first cut segment 154A and the second cut segment 154B of each marker section 154 have respective right ends (broadly, second ends) joining the left end of the adjacent single cut segment of another removable portion section 152. The first cut segment 154A and the second cut segment 154B of each marker section 154 diverge widthwise between their respective left and right ends.

In the illustrated embodiment, each pair of cut segments 154A, 154B is shaped to define a circular trip dot. But it will be understood that the cut segments of the marker sections could be shaped to define other types of markers (e.g., markers of non-circular shapes). The illustrated marker transfer tape 110 comprises markers 144 that are all the same shape and size. Other embodiments can comprise markers that differ in size and/or shape. Each marker 144 has a width MW along the width W of the marker transfer tape 110. In FIGS. 2-5 the removable portion segments 152 are centered on the width MW of the markers 144. By contrast, in FIG. 7, removable portion segments 152 are not centered on the width MW of the markers 144. In one or more embodiments, the width MW of each marker 144 is in an inclusive range of from 0.01″ to 0.5″ (0.254 mm to 12.7 mm), or an inclusive range of 0.02″ to 0.3″ (0.508 mm to 7.62 mm), or an inclusive range of 0.025″ to 0.25″ (0.635 mm to 6.35 mm), or an inclusive range of 0.03″ to 0.1″ (0.762 mm to 2.54 mm), or an inclusive range of 0.04″ to 0.075″ (1.016 mm to 1.905 mm). In the illustrated embodiment having circular markers 144, the marker width MW is the marker diameter and thus the marker width MW is equal to a maker length along the length L of the maker transfer tape 110. In other embodiments, the marker length can differ from the marker width MW.

The spacing of each marker 144 along the length L of the marker transfer tape 110 may vary depending on the design requirements of the article being tested. Each marker 144 is lengthwise from an adjacent marker by the length of the removable portion segment 152 located between the two markers. Furthermore, it is possible that the spacing of the markers 144 along the marker transfer tape 110 may be consistent or may vary along the length of the marker transfer tape 110 so that the removable portion segments 152 may be different lengths along the length L of the marker transfer tape 110. In one embodiment, a ratio of the length of each removable portion segment 152 to the maker length is approximately 2:1. This ratio may be suitable for a trip dot application to approximate the aerodynamic effect of irregular transitions from laminar to turbulent flow and/or certain vortex generators found on full-sized aircraft.

Referring to FIG. 8, in exemplary embodiments, the marker transfer tape 110 is formed into a tape roll from which the marker transfer tape 110 may be unwound and cut to a desired length L.

In general terms, the marker transfer tape 110 is configured for transferring the markers 144 onto a surface S by (i) temporarily adhering the transfer material layer 112 to the surface using the adhesive layer 122, (ii) removing the first removable portion 141 from the surface by separating the first removable portion from the second removable portion 142 and the plurality of markers 144 along the marker separation cut 140, and (iii) removing the second removable portion 142 from the surface by separating the second removable portion from the plurality of markers 144 along the cut 140, whereby the plurality of markers are adhered to the surface and separated from the first and second removable portions.

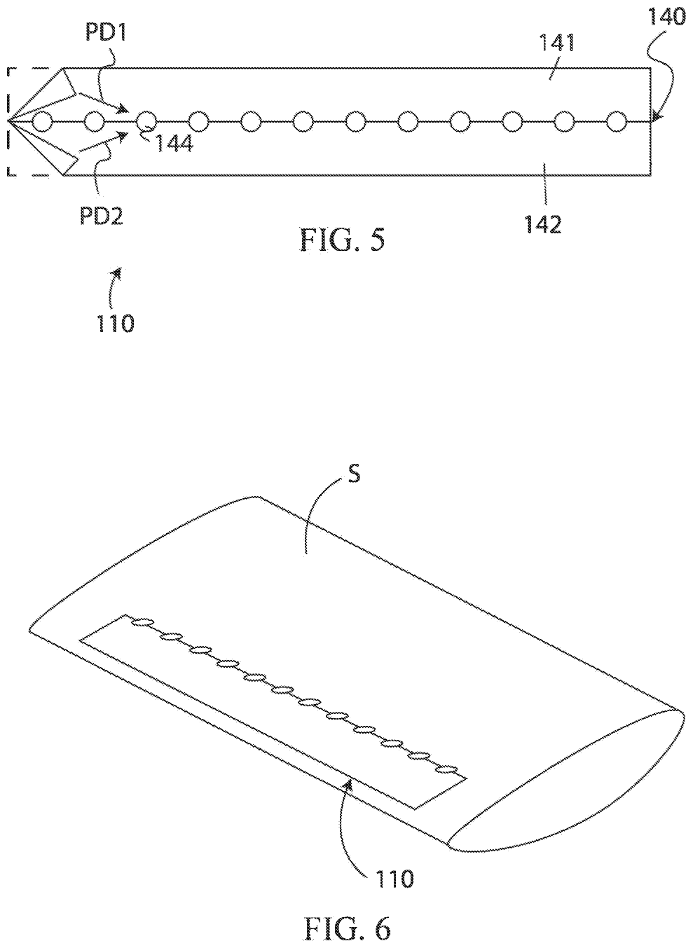

The inventors believe that, in comparison with the conventional marker application strip 10 shown in FIG. 1, the marker transfer tape 110 applies the markers more quickly, more easily, and more accurately. Because the removable portions 141, 142 of the marker transfer tape 110 are removed from the surface S in two steps, the cut segments 154A, 154B along which the removable portions 141, 142 must detach from each marker 144 along only part of each marker's perimeter. Furthermore, because each removable portion 141, 142 only meets the marker 144 along one side, and has no engagement with the opposite side of the marker, the removable portions 141, 142 can be peeled away at an angle to minimizes the tendency of the markers to lift up with the removable portions. For instance, each removable portion 141, 142 can be removed by peeling up an outer corner at a first end of the marker transfer tape and then pulling the peeled-up outer corner toward an opposite second end of the marker transfer tape 110 in a skewed pulling direction PD1, PD2 (FIG. 5) that is skewed widthwise toward the opposite removable portion.

In contrast with the marker transfer tape 110, the prior art conventional marker application strip 10 has a removable portion 18 that meets the markers 16 at cuts 14 that extend around the entire perimeter of each marker. This creates stronger engagement between the removable portion 18 and the markers and allows for no advantageous peeling angles. Hence, in the prior art, the markers 16 are regularly lifted off of the surface S as the removable portion 18 is peeled away. As a result, the person applying the markers must painstakingly pick individual markers from the peeled off material and individually place them back on the surface at the desired location. By contrast, the inventors believe that the marker transfer tape 110 of the present disclosure allows for much more consistent detachment of the removable portions 141, 142 from the markers 144, thereby reducing application time and improving application accuracy.

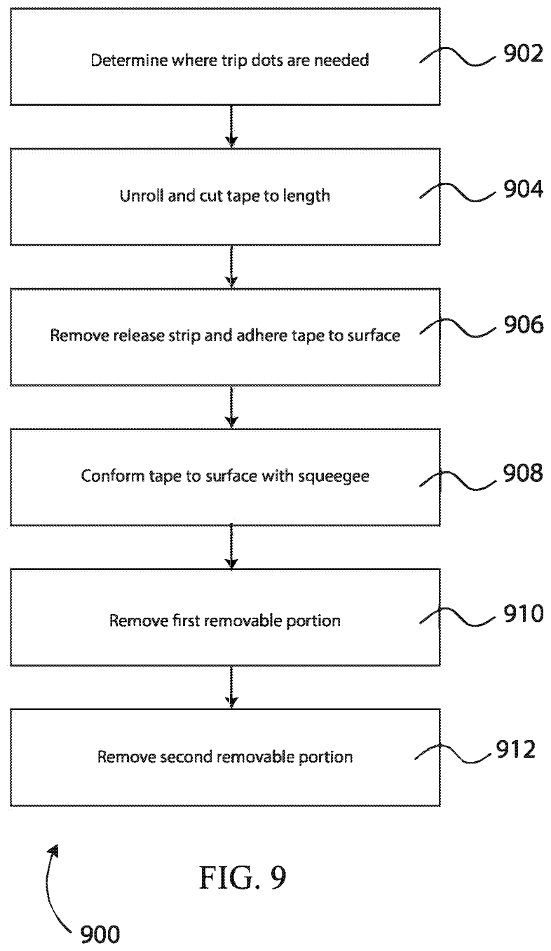

Referring to FIG. 9, an exemplary method of using the marker transfer tape 110 to apply markers 144 to a surface S (FIG. 6) is generally indicated at reference number 900. At an initial step 902, a determination is made as to where the markers 144 need to be placed on the surface S of an article being tested. For example, this can involve determining the locations on small-scale models of an airplane wing article where a laminar boundary layer would be observed but which correspond to locations that would have a turbulent boundary layer at full-scale. Based on where markers 144 are needed, it is also determined in step 902 the number of markers 144 required and corresponding length(s) of marker transfer tape 110 that should be cut from the roll. Once this determination is made, in step 904, a technician unrolls some of the marker transfer tape 110 and cuts one or more lengths of marker transfer tape 110 in accordance with the requirements determined in step 902.

In step 906, the release strip 132 is removed from each cut length of marker transfer tape 110, and the remainder of the marker transfer tape is pressed onto the surface at the desired location so that the adhesive layer 124 adheres the transfer material layer 112 to the surface. In optional step 908, a squeegee is used to press the marker transfer tape 110 into very close contact with the surface, removing any air bubbles from the interface between the marker transfer tape and the surface.

In step 910, the first removable portion 141 of the marker transfer tape 110 is removed from the surface, and in step 912, the second removable portion is removed from the surface. Referring to FIG. 5, in an exemplary embodiment, step 910 comprises peeling up a corner of the first removable portion 141 at a first end of the marker transfer tape 110 and pulling the peeled-up corner of the first removable portion toward an opposite second end of the marker transfer tape in a skewed pulling direction PD1 that is skewed from a true lengthwise direction in a first widthwise direction toward the second removable portion 142. Likewise, the step 912 comprises peeling up a corner of the second removable portion 142 at an end of the marker transfer tape 110 and pulling the peeled-up corner toward an opposite end of the marker transfer tape in a skewed pulling direction PD2 that is skewed from a true lengthwise direction in a second widthwise direction toward where the first removable portion 141 was located prior to removal. The technician may press or hold down the marker 144 while peeling the removable portions 141, 142.

In the embodiment of the marker transfer tape 110 shown in FIG. 2, either one of the removable portions 141, 142 can be removed first because the cut segments 154A at which the removable portion 141 meets the markers 144 are the same length as the cut segments 154B at which removable portion 142 meets the markers. But in the marker transfer tape embodiment shown in FIG. 7, it is preferable that removable portion 141 is removed before removable portion 142. This is because in FIG. 7, the removable portion 141 meets the markers 144 at cut segments 154A that extend more than half the perimeter of each marker 144. Removing the removable portion 141 that meets the markers 144 at the greater-length cut segments 154A first makes it easier to detach the second removable portion 142 from the markers because the remaining cut segments 154B are shorter. Moreover, the second removable portion 142 helps hold the markers 144 in place on the surface S while the first removable portion 141 is being detached at the greater-length cut segments 154A.

Upon completion of trip dot application method 900, markers 144 are applied to the surface S at a plurality of spaced apart locations, and no other portion of the marker transfer tape 110 remains on the surface. The inventors believe that, compared with conventional placing of trip dots to a surface, the method 900 achieves quicker, easier, and more accurate trip dot application.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A marker transfer tape having a length and a width, the marker transfer tape comprising:
a transfer material layer extending along the length and width of the marker transfer tape, the transfer material layer having a thickness and a bottom side and a top side spaced apart along the thickness;
an adhesive layer along the bottom side of the transfer material layer, the adhesive layer comprising pressure sensitive adhesive; and
a marker separation cut formed in the marker transfer tape, the marker separation cut extending along the length of the marker transfer tape and located centrally along the width of the marker transfer tape, the marker separation cut spanning at least the thickness of the transfer material layer such that the marker separation cut defines a first removable portion on a first side of the marker separation cut, a second removable portion on a second side of the marker separation cut, and a plurality of markers between the first removable portion and the second removable portion, the plurality of markers being spaced along the length of the marker transfer tape.

2. The marker transfer tape of claim 1, wherein the marker transfer tape is configured for transferring the markers onto a surface by:
temporarily adhering the transfer material layer to the surface using the adhesive layer;
removing the first removable portion from the surface by separating the first removable portion from the second removable portion and the plurality of markers along the marker separation cut; and
removing the second removable portion from the surface by separating the second removable portion from the plurality of markers along the cut whereby the plurality of markers are adhered to the surface and separated from the first and second removable portions.

3. The marker transfer tape of claim 1, wherein the separation cut comprises a plurality of removable portion sections and a plurality of marker sections that alternate along the length of the marker transfer tape, wherein each marker section comprises a first cut segment and a second cut segment.

4. The marker transfer tape of claim 3, wherein each removable portion section comprises a single cut segment having a first end and a second end spaced apart along the length of the marker transfer tape, the first and second removable portions meeting at each of the removable portion sections.

5. The marker transfer tape of claim 3, wherein the first cut segment and the second cut segment of each marker section have respective first ends joining the second end of the single cut segment of one removable portion section and respective second ends joining the first end of the single cut segment of another removable portion section.

6. The marker transfer tape of claim 5, wherein the first cut segment and the second cut segment of each marker section diverge widthwise between their respective first ends and their respective second ends.

7. The marker transfer tape of claim 3, wherein the first removable portion meets the plurality of markers along the first cut segments and wherein the second removable portion meets the plurality of markers along the second cut segments.

8. The marker transfer tape of claim 3, wherein each marker has a width along the width of the marker transfer tape and the removable portion segments are centered on the widths of the marker segments.

9. The marker transfer tape of claim 3, wherein each marker has a width along the width of the marker transfer tape and the removable portion segments are not centered on the widths of the marker segments.

10. The marker transfer tape of claim 1, wherein the plurality of markers are all a same marker shape.

11. The marker transfer tape of claim 1, wherein the plurality of markers are circular.

12. The marker transfer tape of claim 1, the transfer material layer is a vinyl polymer.

13. The marker transfer tape of claim 1, wherein the thickness of the transfer material layer is in an inclusive range of from 0.5 mil to 25 mil.

14. The marker transfer tape of claim 1, wherein the markers are trip dots.

15. The marker transfer tape of claim 1, wherein the markers are evenly spaced along the length of the marker transfer tape.

16. The marker transfer tape of claim 1, wherein the marker transfer tape is formed into a roll of transfer tape.

17. The marker transfer tape of claim 1, further comprising a release layer covering the adhesive layer.

18. A method for applying markers to a surface, the method comprising:
adhering a marker transfer tape to a surface, the marker transfer tape having a length and a preformed marker separation cut extending along the length, the preformed marker separation cut defining plurality of markers spaced apart along the length of the marker transfer tape, a first removable portion along a first side of the plurality of markers and a second removable portion along the second side of the plurality of markers;
removing the first removable portion of the marker transfer tape from the surface by separating the first removable portion from a remainder of the marker transfer tape along the preformed marker separation cut; and
removing a second removable portion of the marker transfer tape from the surface by separating the second removable portion from the markers along the preformed marker separation cut, whereby the markers are applied to the surface without the first and second removable portions.

19. The method of claim 18, wherein removing the first removable portion of the marker transfer tape comprises peeling up a corner of the first removable portion at a first end of the marker transfer tape and pulling the peeled-up corner of the first removable portion toward an opposite second end of the marker transfer tape at a skewed pulling angle that is skewed in a first widthwise direction toward the second removable portion.

20. The method of claim 19, wherein removing the second removable portion of the marker transfer tape further comprises peeling up a corner of the second removable portion and pulling the peeled-up corner of the second removable portion at a skewed pulling angle that is skewed in a second widthwise direction opposing the first widthwise direction.
